(19) United States
(12) Patent Application Publication
(10) Pub. No.: US 2007/0160242 A1
(43) Pub. Date: Jul. 12, 2007

(54) Method to adjust a hearing system, method to operate the hearing system and a hearing system

(75) Inventors: Nail Cadalli, Champaign, IL (US); Hansueli Roeck, Hombrechtikon (CH); Michael Kramer, Urbana, IL (US); Stefan Launer, Zurich (CH); Silvia Allegro Baumann, Unteraegeri (CH); Marcel Joho, Champaign, IL (US)

Correspondence Address: PEARNE & GORDON LLP, 1801 EAST 9TH STREET, SUITE 1200, CLEVELAND, OH, 44114-3108, US

(73) Assignee: Phonak AG, Stafa (CH)

(21) Appl. No.: 11/330,888

(22) Filed: Jan. 12, 2006

(51) Int. Cl. H04R 25/00

(52) U.S. Cl. 381/312; 381/315

(57) ABSTRACT

A method to adjust a hearing system comprising two hearing devices to be at least partly inserted into left and right ear of a head is disclosed, each hearing device comprising at least one microphone. By the steps of: exposing the hearing devices to a predefined sound source positioned at a predefined angle of incidence with respect to the head, determining power levels of signals recorded by the microphones as a function of angles of incidence of the sound source being positioned at different angle of incidence in order to obtain a relation between power levels and angle of incidence for said sound source, and storing said relation in a memory unit contained in at least one of the hearing devices, a head-related transfer function is automatically taken into account while the hearing system is adapted to the individual. Therewith, an optimal adaptation of the hearing system is obtained also resulting in precise sound source localization during an operating mode. Furthermore, a method to operate a hearing device, that is adjusted according to the inventive method to adjust the hearing device, as well as hearing systems.

### TECHNICAL FIELD

The present invention is related to a method to adjust a hearing system comprising two hearing devices to be at least partly inserted into a left and right ear of a head, to a method to operate the hearing system adjusted accordingly as well as to hearing systems.

### BACKGROUND OF THE INVENTION

There are basically two proven ways of increasing intelligibility above that obtainable with a well-fitted conventional hearing device that delivers sound at a comfortable level. One way is to move the hearing device microphone—or some auxiliary microphone—closer to the source of interest. This increases the level of direct sound compared to reverberant sound and background noise. Unfortunately, moving closer to the source, or positioning a remote microphone near the source, is not always practical.

The other proven solution is to use some type of directional microphones that are used to obtain directional characteristics so as to have minimum sensitivity for sounds coming from the direction of dominant noise sources. Such a group of microphones is often referred to as a microphone array or as a beam forming array meaning that at least two microphones or a microphone having at least two ports are involved.

There are various approaches in the array signal processing literature to finding direction of arrival of multiple sources from superimposed signals in noise incident on an array of sensors. One can divide the known approaches basically into three general groups:

A first group is based on maximizing the steered response power of a beam former. The location estimate is derived directly from a filtered, weighted and summed version of the signal data received at the sensors. The location estimate is computed by finding the location that maximizes the output power. The main difficulty with these methods is that the steered response usually does not have a global peak and has lots of local maxima. Thus a maximum-likelihood-type optimization technique is usually not efficient both in accuracy and in computational complexity. Computationally less complex iterative methods can be used for maximum likelihood estimation, but they introduce overall system delay.

A second group is based on high-resolution spectral estimation techniques including autoregressive modeling, minimum variance spectral estimation, and Eigenvalue-decomposition-based techniques such as the popular MUSIC (multiple signal classification) algorithm. These methods rely on spatial signal correlation matrix, which is usually derived from observed data with assumptions such as the sources and noise being stationary. Those assumptions are not satisfied by speech signals, and the computational cost of Eigenvalue-decomposition is very high for a hearing device application. Furthermore, these methods are designed for narrowband signals. They can be extended to wideband signals, such as speech, in expense of at least a linear increase in computation with the number of frequency bins. These methods are also quite sensitive to source and sensor modeling errors as well as to reverberation.

A third group is based on time delay of arrival information—e.g. basically ITD-(interaural time difference)—, where the methods calculate source locations from a set of delay estimates measured across various combinations of microphones. These methods use temporal correlation of the signals to compute accurately the ITD information. These methods are theoretically good for free field application. However, for hearing device application, where there is a head causing head shadowing between sensors for high frequencies, ITD information is useful only in the lower frequency bands. Due to the temporal correlation estimation, these methods require higher computational power than a hearing device can afford.

All the above-mentioned methods from array signal processing literature perform poorly when the number of sensors (e.g. microphones in a hearing device) and the number of observations are small, and the number of sources in the incident signal is large. However, the main disadvantage of these solutions is the computational complexity. Due to the low-power requirements of a digital signal processor in a hearing device, it is difficult to run such methods on a hearing device. Furthermore, most of the methods rely on the availability of signals from both hearing devices of a binaural hearing system.

Direction of arrival of a source signal is important information for a hearing device to adjust its parameters according to the direction of the source.

Location estimation using a binaural hearing instrument is difficult by using known methods. In particular, the known techniques show disadvantages in terms of
1. accuracy, since there is a smaller number of sensors than that of known microphone array signal processing techniques;
2. complexity, since most known methods are computationally expensive requiring Eigenvalue-decomposition, correlation estimation, or iterations, which all effects the overall delay.

It is therefore an object of the present invention to overcome the above-mentioned disadvantages and to provide an improved method to localize a sound source.

### SUMMARY OF THE INVENTION

The present invention is related to a method to adjust a hearing system comprising two hearing devices to be at least partly inserted into left and right ear of a head, each hearing device comprising at least one microphone, comprising the steps of:
exposing the hearing devices to a predefined sound source positioned at a predefined angle of incidence with respect to the head,
determining power levels of signals recorded by the microphones as a function of angles of incidence of the sound source being positioned at different angle of incidence in order to obtain a relation between power levels and angle of incidence for said sound source, and
storing said relation in a memory unit contained in at least one of the hearing devices.

An important advantage of the present invention is the fact that a head-related transfer function is automatically taken into account while the hearing system is adapted to the individual. Therewith, an optimal adaptation of the hearing system is obtained also resulting in precise sound source localization during the operating mode. In cases where a so called KEMAR, i.e. a dummy head, is used during the adjustment mode, a standardized relation is obtained to be stored in the memory unit, which relation does not reflect the individual shape of a user's head but still give adequate results for a later good operation of the hearing system.

In an embodiment of the invention, the power levels are determined in predefined frequency ranges.

In a further embodiment, power ratios are calculated using the determined power levels. Therewith, the multiple power levels from the microphones are packed into the fewer power ratios.

In a further embodiment, said relation is partitioned into segments covering complete range of 360 degrees, and is inverted in each segment. The segmentation allows a definite inversion of the between power ratios and angle of incidence.

A further embodiment comprises the step of comparing the power ratios to predefined threshold levels and by partitioning said relation as a result of the comparison.

In a further embodiment of the present invention, said relation is determined in different acoustic situations, taking into account the impact on the relation between the power levels and power ratios, respectively, and the angle of incidence. Acoustic situations might be defined as music, noise, speech in calm situations, speech in restaurant, living room, car noise, etc.

Once the hearing system is adapted to the hearing device user according to the above-mentioned adjustment phase, the hearing system is ready to be operated. Therefore, a method to operate a hearing system is provided that is adjusted according to the adjustment phase. The hearing system comprises two hearing devices to be at least partly inserted in or behind a left and right ear of a user's head, each hearing device comprising at least one microphone. The method to operate the hearing system comprises the steps of:
recording input signals of the at least two microphones,
calculating power levels of the input signals, and
determining an angle of incidence using the calculated power levels and a predetermined relation between power levels and angle of incidence.

An advantage of the present method to operate the hearing system lies in the fact that a precise determination of a location of a sound source is achieved. This in particular because the head-related transfer function is considered during the adjustment phase of the hearing system.

Furthermore, this invention proposes a computationally cheaper method to localize a sound source given a binaural hearing system with at least two microphones. A binaural hearing system using only the left and right sensors is subject to front-back ambiguity in localization. By using also the front-back signals, the front-back ambiguity can be resolved. For such an embodiment, at least four microphones must be used. The method used in this invention is capable of locating the sound source that is dominant in power within the sound field.

In an embodiment of the invention, the power levels are determined in predefined frequency ranges.

In a further embodiment, power ratios are calculated using the determined power levels.

In yet another embodiment of the present invention, the method comprises the steps of
determining a segment, in which the sound source is located, and
localizing the sound source in the segment by using a predetermined relation between the power levels and the angle of incidence, said relation being only valid in the determined segment.

A further embodiment comprises the steps of comparing the power ratios to predefined threshold levels and partitioning said relation as a result of the comparison.

In a further embodiment of the present invention, the momentary acoustic situation is determined with a classifier, for example, the information regarding the momentary acoustic situation being used to select the most suitable relation between the power ratio or power levels, respectively, and the angle of incidence.

A further embodiment of the present invention comprises the steps of
determining a momentary acoustic situation, and
selecting a specific predetermined relation between the power levels and the angle of incidence in dependence on the momentary acoustic situation.

Furthermore, a hearing system comprising two hearing devices to be at least partly inserted into left and right ear of a head, each hearing device comprising at least one microphone, is provided, the hearing system comprising:
means for exposing the hearing system to a predefined sound source positioned at a predefined angle of incidence with respect to the head,
means for determining power levels of signals recorded by the microphones as a function of angles of incidence of the sound source being positioned at different angle of incidence in order to obtain a relation between power levels and angle of incidence for said sound source, and
means for storing said relation in a memory unit contained in at least one of the hearing devices.

In a further embodiment, the system comprises means for determining the power levels in predefined frequency ranges.

In yet another embodiment of the present invention, the system comprises means for calculating power ratios using the determined power levels.

In another embodiment of the present invention, the system comprises
means for partitioning said relation into segments covering complete range of 360 degrees, and
means for inverting said relation in each segment.

In yet another embodiment, the system comprises
means for comparing the power ratios to predefined threshold levels, and
means for partitioning said relation as a result of the comparison.

In a further embodiment, the system comprises means for determining said relation in different acoustic surround situations.

Finally, a hearing system adjusted according to the adjustment phase is provided comprising two hearing devices to be at least partly inserted into left and right ear of a user's head, at least one hearing device comprising:
at least one microphone,
means for recording input signals of the at least two microphones,
means for calculating power levels of the input signals, and
means for determining an angle of incidence using the calculated power levels and a predetermined relation between power levels and angle of incidence.

In a further embodiment of the present invention, the hearing system comprises means for determining the power levels in predefined frequency ranges.

In yet another embodiment of the present invention, the hearing system comprises means for calculating power ratios using the determined power levels.

In a further embodiment of the present invention, the hearing system comprises
means for determining a segment, in which the sound source is located, and
means for localizing the sound source in the segment by using the predetermined relation between the power levels and the angle of incidence, said relation being only valid in the determined segment.

In a further embodiment of the present invention, the hearing system comprises
means for comparing the power ratios to predefined threshold levels, and
means for determining the segment as a result of the comparison.

In yet another embodiment of the present invention, the hearing system comprises
means for determining a momentary acoustic situation, and
means for selecting a specific predetermined relation between the power levels and the angle of incidence in dependence on the momentary acoustic situation.

In yet another embodiment of the present invention, the hearing system comprises
means for determining signal onsets, and
means for determining the direction of incidence only or predominantly only during such onset periods.

In yet another embodiment of the present invention, the hearing system comprises
means for determining mean power levels, and
means for determining the direction of incidence only or predominantly only for signals which have at least equal or preferably higher power levels than the mean power levels.

In yet another embodiment of the present invention, the hearing system comprises
performing the adjusting phase upon an artificial head (e.g. KEMAR) instead of upon an individual person.

It is emphasized that the power-based approach proposed by this invention not only works for a binaural hearing system but still works for a bilateral hearing system for which the transmission between the hearing devices must not be of high capacity—as needed for a binaural operation.

### BRIEF DESCRIPTION OF THE DRAWINGS

The present invention is further explained in more detail by way of examples shown in drawings.

FIG. 1 shows a top view of a hearing system user with a left and a right hearing device,

FIG. 2 shows a graph of a power ratio as a function of angle of incidence, and

FIG. 3 shows a block diagram of a hearing system comprising a left and a right hearing device in a schematic view.

### DETAILED DESCRIPTION OF THE INVENTION

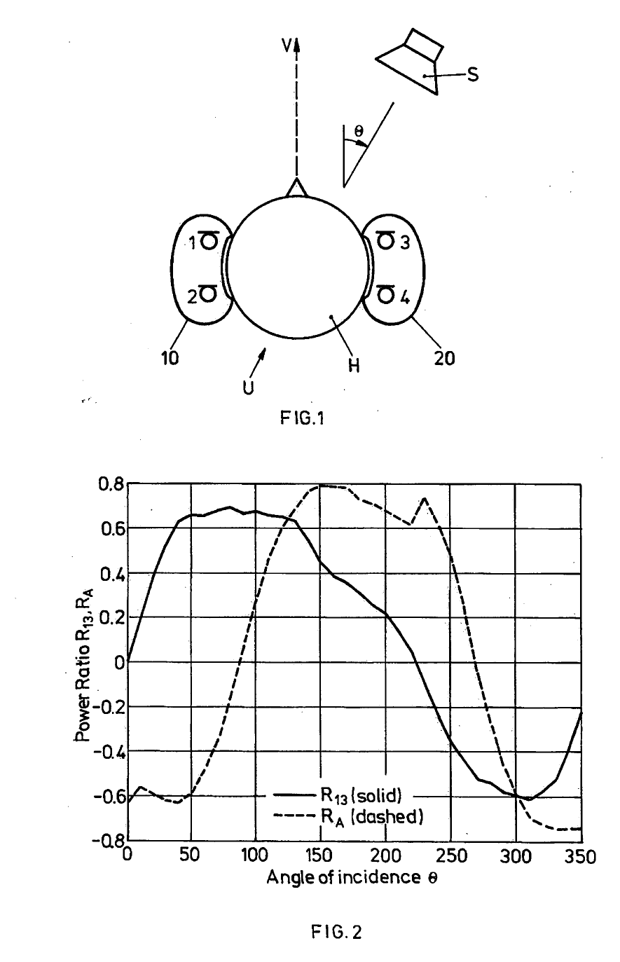

In FIG. 1, a schematic view of a hearing system user U is depicted, the hearing system user's head H being shown from the top. A viewing arrow V indicates the line of sight of the user U wearing a left hearing device 10 and a right hearing device 20. Each of the hearing devices 10 and 20 comprise two microphones 1, 2 and 3, 4, respectively, one being a front microphone and the other being a back microphone. Therefore, the microphones 1 to 4 are referred to the left-front, left-back, right-front and right-back microphone, respectively.

Furthermore, a sound source S is shown at an angle of incidence 9 with regard to the viewing arrow V, i.e. the line of sight of the user U.

The arrangement of FIG. 1 is typical for a binaural hearing system that is implemented using so called BTE-(behind-the-ear) hearing devices. However, it is expressly pointed out that the invention can readily be applied to other types of hearing devices such as ITE-(in-the-ear), CIC-(completely-in-the-canal) or even to implantable devices having corresponding microphones on the outside. Furthermore, the present invention is not only suitable for using in connection with devices to improve the hearing ability of a hearing impaired person, but it can be applied in general communication devices. This is in particular valid for all communication devices, in which a simple and reliable algorithm is used to improve the estimation or determination of the direction of arrival of a sound, or for localizing a sound source S in relation to a particular reference direction. Therefore, the term “hearing device” or “hearing system” must be understood throughout this description as referring to any communication device, or hearing aid, or hearing system etc., be it implantable, worn close to or in the ear of a user, or be it a part of an accessory of any afore-mentioned device, as for example a remote control or a remote microphone.

For the binaural hearing system of FIG. 1, four microphones 1 to 4 are used to illustrate the method according to the present invention. Basically, the method of the present invention comprises two phases: First, the hearing system is adjusted in an adjustment phase, and, second, the hearing system is operated in the operating mode, which is, as it becomes clear later on, based on the adjustments made in the first phase. In the following, the adjustment phase will be explained first, nevertheless, the information given in connection therewith will be useful to understand the functioning of the hearing system in the operating mode.

By the four microphones 1 to 4, it is possible to distinguish between left and right as well as between front and back. The method according to the present invention applies also to a hearing system with more than four microphones that are possibly in a different constellation.

Acoustic signals are recorded or captured by the microphones 1 to 4 and fed to a pre-processing stage, in which beam-formed signals are generated by using only signals of microphones 1 and 2 for the left hearing device 10, and by using only signals of the microphones 3 and 4 for the right hearing device 20, so that each hearing device 10, 20 has directionality instead of being omni-directional for purposes of spatial noise reduction. Due to a typical cardioid shape of the beam pattern resulting from using two microphones, one generally calls this type of such a signal a cardioid.

In the following, reference is often made to a signal with indication of the reference number of one of the microphones. This can either mean a beam-formed microphone signal (cardioid) or an omni-directional microphone signal. In connection with cardioid signals, the reference numbers 1 to 4 therefore refer to the left front-facing cardioid, the left back-facing cardioid, the right front-facing cardioid, and the right back-facing cardioid, respectively. In connection with omni-directional signals, the reference numbers 1 to 4 refer to the left-front, left-back, right-front and right-back microphone signals.

A basic principle of the present invention is the following: an acoustic excitation—i.e. a sound source S—from different directions (different angles of incidence θ) around the head H causes different power levels p at the microphones 1 to 4 of a hearing system, the power level pₙ recorded by the microphone n being defined in the time interval t₁ to t₂ as follows:

$${p}_{n} = \frac{1}{{t}_{2} - {t}_{1}} {\int }_{{t}_{1}}^{{t}_{2}} {( {s}_{n} ( t ) )}^{2} \cdot ⅆ t$$

where sₙ(t) is the input signal as a function of time recorded by the microphone n.

Although the definition for the power level pₙ is given for an analog input signal sₙ(t), the present invention can readily be applied to digital signals which are then processed digitally. As a consequence, the above definition as well as the equations to follow must then be rewritten in the discrete time domain instead of the continuous time domain. Measures similar to power, such as magnitude can be used as well and are functionally equivalent. All of these measures shall be referred to as power levels.

From the power levels p₁ to p₄ recorded by the microphones 1 to 4 and by knowing the location of the sound source S via the corresponding known angle of incidence θ, a reference point is obtained in dependence on the angle of incidence θ. This procedure is repeated for several, possibly for a high number of times, each being done at a different known angle of incidence θ to cover the entire range of 360 degrees. Therewith, relations between the power levels p and the angle of incidence θ are obtained over the entire range of 360 degrees. These relations are stored in a memory unit in at least one of the hearing devices 10 and 20, and form the basis for a later determination of an angle of incidence θ from calculated power levels p₁ to p₄ during the operating mode of the hearing system.

In a further embodiment of the present invention, power ratios are calculated from different power levels p₁ to p₄ obtained via the input signals of the microphones 1 to 4. For example, the left-right power ratio R₁₃, considering the left-front and right-front microphones 1 and 3, is defined as follows:

$${R}_{13} = \frac{{p}_{3} - {p}_{1}}{{p}_{3} + {p}_{1} + ɛ} ,$$

wherein ε is a noise, respectively a regularization term occurring naturally in a practical system, in which a division by zero must be prevented.

Similarly, the front-back ratios, namely R₁₂ and R₃₄, are defined as follows:

$${R}_{12} = \frac{{p}_{2} - {p}_{1}}{{p}_{2} + {p}_{1} + ɛ}$$

$$and$$

$${R}_{34} = \frac{{p}_{4} - {p}_{3}}{{p}_{4} + {p}_{3} + ɛ} .$$

It shall be noted that these or similar ratios can also be computed at least in part in logarithmic domain, This changes the mathematical equation, but not the underlying functional principle, which is presented here.

The left-front, left-back, right-front and right-back signals of the microphones 1 to 4 can be omni-directional microphone signals or cardioid signals.

The power ratios R₁₂, R₃₄ and R₁₃ are defined, for example, in terms of the time-averaged subband powers p₁ to p₄, the subband referring, for example, to a band-pass region in the frequency domain, which may include—for discrete systems—multiple frequency bins in terms of a discrete Fourier transform. In one embodiment, the total power in a frequency range is determined. However, it is possible to carry out the same formulation and come up with a location estimate for each frequency bin individually, as it is the case for another embodiment of the present invention.

Considering a power ratio R_{A} in order to obtain a smooth graph but still distinguish between the two front-back ratios R₁₂ and R₃₄, the following rules can be defined:

$${R}_{13} = \frac{{p}_{3} - {p}_{1}}{{p}_{3} + {p}_{1} + ɛ}$$

$${R}_{A} = \{ \begin{matrix}{R}_{34} for {R}_{13} \geq {t}_{A} \\ {R}_{12} for {R}_{12} \leq {t}_{A}\end{matrix}$$

where t_{A} is a threshold, and R_{A} is the combination of front-back power ratios R₁₂ and R₃₄ in dependence on the threshold t_{A}.

In FIG. 2, the power ratios R₁₃ and R_{A} are plotted as a function of the angle of incidence θ of the sound source S. The resulting graph has a low-order polynomial behavior and shows typical power ratios obtained for a speech signal simulated at various angles of incidence θ around a standardized dummy head—also known under the acronym KEMAR.

A specific advantage of the present invention is obtained by the above-described determination of the power levels and power ratios in that the individual geometric form—e.g. head, ears, hairs, etc.—of a hearing system user is automatically considered when determining the power levels or power ratios in dependence on the angle of incidence for an individual. In other words, the so called head related transfer function (HRTF) is automatically considered and compensated which results in an overall improvement of localizing sound sources S in the operating mode later.

The power levels pₙ, which actually are averaged during the considered time interval t₁ to t₂, are calculated in every frame of an input signal, and are used to calculate power ratios, and, if need be, the power ratios are averaged or smoothed along the entire duration of the signal for this graph. Because of the low-order nature of these graphs, it is possible to fit low-order polynomials to the curves so that the location estimation can be parameterized.

As has been pointed out, the power ratios are computed given specific locations around the user's head H (FIG. 1) during the design—i.e. the adjustment phase—of the parameters of the sound localizer. In the operating mode, a location of a sound source S is estimated given the power ratios. However, the power ratio curve, as a function of the angle of incidence θ, is not invertible because it is not definite. Thus, it is necessary to invert it using additional information in order to obtain the sound source location given the power ratios. In one embodiment, the relation between the power ratios and the angle of incidence—as it is shown for example in FIG. 2—is inverted in a piecewise manner. In order to perform piecewise inversion the graph is divided into segments, in which the relation between power ratio and angle of incidence is definite. The inversion of the relation may then take place in each segment individually. The hybrid approach of this embodiment of the present invention uses both the left-right power ratio R₁₃ and the combined front-back power ratio R_{A} to perform the segmentation. For example, using the front-back power ratio R_{A} helps to segment the left-right power ratio R₁₃ and vice versa. Furthermore, it resolves the front-back ambiguity that would be encountered if we only used the left-right power ratio R₁₃.

In a specific embodiment of the present invention, the entire range from 0 to 360 degrees is divided into four segments I, II, III and IV by using predefined thresholds that are compared to the power ratios. For instance and with a view on FIG. 2, segment I is assigned to the location range—i.e. to angles of incidence θ—where the power ratio R₁₃ is, for example, less than 0.6 but greater than −0.57, and where the power ratio R_{A} is negative. This results in a range covering angles of incidence θ greater than 320 degrees and less than 40 degrees, approximately.

With similar thresholds, segment II covers the angles of incidence θ that are greater than 40 and less than 130 degrees. Furthermore, segment III covers the angles of incidence θ being greater than 130 and less than 240 degrees. Finally, segment IV covers the angles of incidence θ being greater than 240 and less than 320 degrees.

It is pointed out that these specific values for the thresholds are only examples. The idea, however, is to adjust thresholds such that the segments form a partition of the entire range for the angle of incidence θ. In addition, it is also conceivable that the segments I to IV or some of the segments I to IV are overlapping to have overlapping segments. The respective thresholds must then be selected accordingly.

The shape of the power ratio graphs changes slightly depending on the nature of the sound source signal. In addition, the acoustic situation, in which the sound source S is contained, influences the shape of the power ratio graphs. Therefore, it is proposed in a further embodiment of the present invention to determine power levels or power ratios, respectively, for different acoustic situations in order to further optimize sound source localization. In other words, the above-described procedure for determining the relation between power levels and power ratios, respectively, and angle of incidence θ is performed in each acoustic situation the hearing system is adapted to operate in. Therefore, a set of optimum localizer coefficients are computed and stored in a memory unit of the hearing system for each acoustic situation. If a particular acoustic situation is detected—either by the hearing system itself or by other means—the corresponding coefficients or relations between power levels and power ratios, respectively, and angle of incidence θ are accessed for operating the hearing system.

For example, if the acoustic situation is detected to be speech in a restaurant then the localizer parameters for this particular acoustic situation is accessed in the memory unit and loaded into the working memory for operating the hearing system.

The power ratio profiles—i.e. the power ratios as a function of the angle of incidence, also called the relation between power ratio and angle of incidence θ—can change in accordance with certain parameters. In a further embodiment of the present invention, it is therefore proposed to adjust the hearing system in accordance to these parameters. For each parameter or parameter value a power ratio profile or a power level profile is stored in the memory unit of at least one of the two hearing devices. In the operating mode of the hearing system, means are provided to determine or estimate the respective parameters or parameter values in order to select the most appropriate power ratio profile or power level profile, respectively, of the set available in the memory unit of the hearing device.

The parameters can be, for example, one of the following:
Input spectrum: Since each input signal type—such as speech, music, or noise—has different spectral characteristics, the profile of the power ratios change slightly depending on the input signal. For speech signals, the energy is mostly concentrated in the lower bands, and since one looks at the higher frequency bands for location information, the procedure becomes quite sensitive to the input signal. One approach is to change the localization parameter set depending on the input signal using information about the type of the input signal, which is provided by other means in a hearing system, as for example by a classifier as disclosed in WO 01/20 965 or its corresponding U.S. Pat. No. 6,910,013, for example.
Type of input signal (omni-directional or cardioid): This affects the directionality of the microphones. More importantly, there are certain nulls in the cardioid patterns where almost no signal power can be received from those directions. A source located in those directions then cannot be detected.
Single or multiple input or noise: This alters the power pattern that is parameterized for a single source. If the number of dominant sources is not one, that is, if the power levels or ratios, respectively, of multiple sources are close to each other's, then it is quite difficult to locate the sources with this type of localizer. Thus, the effect of noise or the interference depends on the levels of noise (signal-to-noise ratio)-SNR and interference SNR. As a remedy to this effect, the power ratios can be calculated during sufficiently high SNR (signal-to-noise-ratio) periods or during onsets only. Additionally, measuring the power ratios in individual frequency bands and computing a histogram over time and/or frequency helps to resolve the individual source directions for sources which do not completely overlap in time and frequency.
On the other hand, a flat histogram without prominent peaks is an indicator for a diffuse and/or reverberant acoustic situation.

As has been pointed out, the power ratio graph is split into segments—e.g. into the four segments I to IV as described in connection with FIG. 2—, the segments being determined by suitable thresholds. In these segments, the relation between the power ratio and the angle of incidence is inverted by first fitting polynomials, which can be of second order, to the power ratio graph, and, thereafter, inverting the polynomials via the solution of a quadratic equation in order to obtain the inverse relation, which is not a polynomial anymore and which includes square root operation, that represents the location (or angle of incidence) as a function of power ratio. In these embodiments, the inverse of the relation is then stored in a memory unit of a hearing device for later access when a angle of incidence is to be determined as a function of the power ratios, which is the conclusion of the adjustment or design stage of the hearing system.

In the normal operating mode of the localizer, the power ratios R₁₃ and R_{A} are calculated, using time-average power values, for each frame of the input signal. Using thresholds on the power ratio R₁₃ and R_{A}, a decision is made about which segment those power ratios belong to. Then, the locations (i.e. angle of incidence) are computed using the inverse relation specific to this segment. The size of each signal frame can be adjusted depending on the signal properties. The frame should be long enough to have an average power value especially for non-stationary signals. However, it should not be too long either; otherwise the method cannot accommodate moving sources.

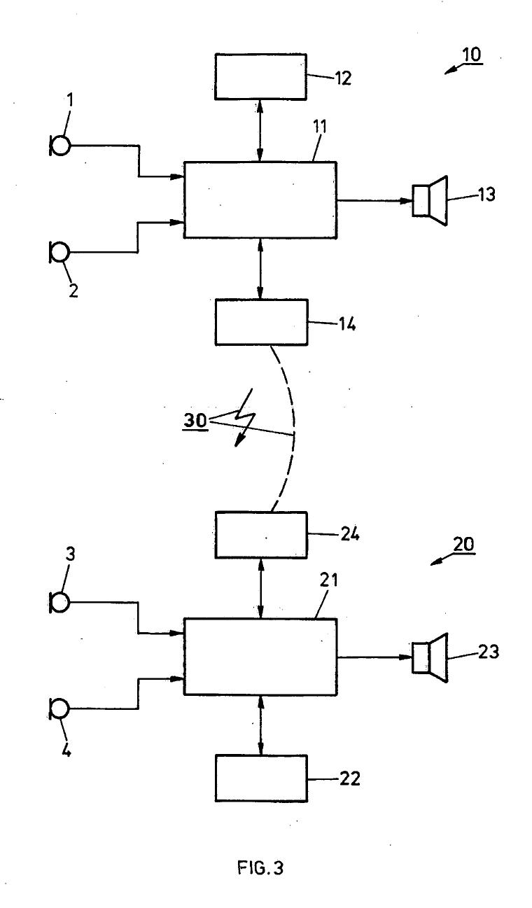

FIG. 3 shows a block diagram of a hearing system in a schematic view. The hearing system comprises two hearing devices 10 and 20 for the left and the right ear of a user U (FIG. 1). The hearing devices 10 and 20 are symmetrical in that they have identical blocks. The hearing device 10 has two microphones 1 and 2, a signal processing unit 11, a memory unit 12, a loudspeaker 13 that is often called receiver in the technical field of hearing systems, and a transceiver unit 14 that enables the communication with the hearing device 20. The microphones 1 and 2 are operationally connected to the signal processing unit 11 and record acoustic signals which are processed in the signal processing unit 11. The processing is dependent on the set of parameters that have been loaded from the memory unit 12 into the working memory (not shown in FIG. 3) of the signal processing unit 11, and is dependent on other information made available to the signal processor unit 11. An output signal is fed as result of the processing in the signal processing unit 11 to the receiver 13, which might also be another type of actuator for stimulating the acoustic nerve. In addition, the result of the processing is transmitted to the second hearing device 20 via the transmitter unit 14 together with other information generated in the signal processing unit 11. Such other information might be information of a classifier that was able to give an estimate of a momentary acoustic situation, for example, or other useful information which allow improving the hearing of the hearing system user.

The hearing system depicted in FIG. 3 can be a binaural hearing system or a bilateral hearing system. For a binaural hearing system, the complete information available in one hearing device is made available via transmission to the other hearing device for further processing. For a bilateral hearing system, the information available in one hearing device is processed to a certain extent, and only the processed or some of the processed information is transmitted to the other hearing device for further processing.

The second hearing device 20 of the hearing system of FIG. 3 is identically built compared to the first hearing device 10. The identity of the two hearing device is not mandatory. It is conceivable that one of the hearing devices 10, 20 incorporates functionality of the other hearing device and that information needed by the other hearing device is transmitted via a link 30 between the two. In connection with such an embodiment of the present invention, the hearing device in which most of the signal processing is performed, is called the master while the other hearing device is called the slave.

In FIG. 3, the link 30 between the hearing devices 10 and 20 is indicated by a dashed line as well as by an arrow to emphasize that the link 30 can be a wireless or a wired link irrespective of the fact of whether the hearing system is a binaural or a bilateral hearing system.

Having thus shown and described what is at present considered to be the embodiments of the invention, it should be noted that the same has been made by way of illustration and not limitation. Accordingly, all modifications, alterations and changes coming within the sprit and scope of the invention are herein meant to be included.

1. A method to adjust a hearing system comprising two hearing devices to be at least partly inserted into left and right ear of a head, each hearing device comprising at least one microphone, the method comprising the steps of:
exposing the hearing devices to a predefined sound source positioned at a predefined angle of incidence with respect to the head,
determining power levels of signals recorded by the microphones as a function of angles of incidence of the sound source being positioned at different angle of incidence in order to obtain a relation between power levels and angle of incidence for said sound source, and
storing said relation in a memory unit contained in at least one of the hearing devices.

2. The method of claim 1, wherein the head is a head of an individual user or a dummy head.

3. The method of claim 1, further comprising the step of determining the power levels in predefined frequency ranges.

4. The method of one of claim 1, further comprising the step of calculating power ratios using the determined power levels.

5. The method of claim 1, further comprising the steps of:
partitioning said relation into segments covering complete range of 360 degrees, and
inverting said relation in each segment.

6. The method of claim 5, further comprising the steps of:
comparing the power ratios to predefined threshold levels,
partitioning said relation as a result of the comparison.

7. The method of one of the claims 1, further comprising the step of determining said relation in different acoustic surround situations.

8. A method to operate a hearing system adjusted according to claim 1, the hearing system comprising two hearing devices to be at least partly inserted into left and right ear of a user's head, each hearing device comprising at least one microphone, the method comprising the steps of:
recording input signals of the at least two microphones,
calculating power levels of the input signals, and
determining an angle of incidence using the calculated power levels and a predetermined relation between power levels and angle of incidence.

9. The method of claim 8, further comprising the step of determining the power levels in predefined frequency ranges.

10. The method of claim 8, further comprising the step of calculating power ratios using the determined power levels.

11. The method of claim 8, further comprising the steps of:
determining a segment, in which the sound source is located, and
localizing the sound source in the segment by using the predetermined relation between the power levels and the angle of incidence, said relation being only valid in the determined segment.

12. The method of claim 11, further comprising the steps of:
comparing the power ratios to predefined threshold levels, and
determining the segment as a result of the comparison.

13. The method of claim 8, further comprising the steps of:
determining a momentary acoustic situation, and
selecting a specific predetermined relation between the power levels and the angle of incidence in dependence on the momentary acoustic situation.

14. A hearing system comprising two hearing devices to be inserted into left and right ear of a head, each hearing device comprising at least one microphone, the method comprising the steps of:
means for exposing the hearing system to a predefined sound source positioned at a predefined angle of incidence with respect to the head,
means for determining power levels of signals recorded by the microphones as a function of angles of incidence of the sound source being positioned at different angle of incidence in order to obtain a relation between power levels and angle of incidence for said sound source, and
means for storing said relation in a memory unit contained in at least one of the hearing devices.

15. The hearing system of claim 14, wherein the head is a head of an individual user or a dummy head.

16. The hearing system of claim 14, further comprising means for determining the power levels in predefined frequency ranges.

17. The hearing system of claim 14, further comprising means for calculating power ratios using the determined power levels.

18. The hearing system of claim 14, further comprising:
means for partitioning said relations into segments covering complete range of 360°, and
means for inverting said relation in each segment.

19. The hearing system of claim 18, further comprising:
means for comparing the power ratios to predefined threshold levels, and
means for partitioning said relations as a result of the comparison.

20. The hearing system of claim 14, further comprising means for determining said relations in different acoustic surround situations.

21. A hearing system adjusted according to claim 14 comprising two hearing devices to be inserted into left and right ear of a user's head, at least one hearing device comprising:
at least one microphone,
means for recording input signals of the at least two microphones,
means for calculating power levels of the input signals, and
means for determining an angle of incidence using the calculated power levels and a predetermined relation between power levels and angle of incidence.

22. The hearing system of claim 21, further comprising means for determining the power levels in predefined frequency ranges.

23. The hearing system of claim 21, further comprising means for calculating power ratios using the determined power levels.

24. The hearing system of claim 21, further comprising:
means for determining a segment, in which the sound source is located, and
means for localizing the sound source in the segment by using the predetermined relation between the power levels and the angle of incidence, said relation being only valid in the determined segment.

25. The hearing system of claim 24, further comprising:
means for comparing the power ratios to predefined threshold levels, and
means for determining the segment as a result of the comparison.

26. The hearing system of claim 21, further comprising:
means for determining a momentary acoustic situation, and
means for selecting a specific predetermined relation between the power levels and the angle of incidence in dependence on the momentary acoustic situation.
